(19) United States
(12) Patent Application Publication
(10) Pub. No.: US 2011/0004784 A1
(43) Pub. Date: Jan. 6, 2011

(54) DATA ACCESSING METHOD AND DATA ACCESSING SYSTEM UTILIZING THE METHOD

(76) Inventors: Shih-Hung Lan, Hsinchu County (TW); Sheng-I Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/754,606

(22) Filed: Apr. 5, 2010

(30) Foreign Application Priority Data
Jul. 2, 2009 (TW) 098122405

(51) Int. Cl. G06F 11/20

(52) U.S. Cl. 714/5; 714/3; 714/E11.071; 714/E11.085

(57) ABSTRACT

A data accessing method applied to a data accessing system, comprising: (a) performing a logic operation to a plurality of data units to generate at least one logic operation data unit; (b) performing an anti logic operation to the logic operation data unit and an other data unit to obtain a recovery data unit wherein the other data unit comprises the data units except a specific data unit in the data units; and (c) replacing the specific data unit with the recovery data unit, when the specific data unit is read and is found having an error.

### BACKGROUND OF THE INVENTION

1. Field of the Invention

The present invention relates to a data accessing method and a data accessing system utilizing the method, and particularly relates to a data accessing method, which utilizes logic operation to increase data correctness, and a data accessing system utilizing the method.

2. Description of the Prior Art

In a conventional storage apparatus, Error Correcting Code (ECC) is always utilized to protect the data stored in the storage apparatus. For example, ECC corresponding to data can be utilized to correct error when the data stored in a storage apparatus is found having error. Error correction utilizing ECC has limited error correction ability, however. For example, ECC can not be utilized for error correction when error data amount is larger than a specific value (ex. N bytes). Necessary calculation amount will largely increase if the ECC protection ability (i.e. error correction ability) is desired to improve, thus accessing speed will be slowed. In modern electronic apparatuses, storage apparatuses (ex. Flash Memory) are always utilized to replace with conventional hard disks. In this structure, it will consume a lot of time and operation cost if large amount of ECC is utilized to perform error correction, thus high speed accessing requirement of modern electronic apparatus can not be matched.

### SUMMARY OF THE INVENTION

Accordingly, one objective of the present invention is to provide a data accessing method and system, which utilizes logic operation to compute recovery data, such that the recovery data can be utilized to substitute original data when the original data includes too much error. By this way, the data correctness can increase.

One embodiment of the present invention discloses a data accessing method applied to a data accessing system, comprising: (a) performing a logic operation to a plurality of data units to generate at least one logic operation data unit; (b) performing an anti logic operation to the logic operation data unit and an other data unit to obtain a recovery data unit wherein the other data unit comprises the data units except a specific data unit in the data units; and (c) replacing the specific data unit with the recovery data unit, when the specific data unit is read and is found having an error.

One embodiment of the present invention discloses a data accessing system comprising at least one storage apparatus, a logic operation apparatus and at least one storage apparatus controller. The logic operation apparatus performs a logic operation to a plurality of data units to generate at least one logic operation data unit before the data units are stored to the storage apparatus, and for performing an anti logic operation to the logic operation data unit and an other data unit to obtain a recovery data unit wherein the other data unit comprises the data units except a specific data unit in the data units. The storage apparatus controller controls the storage apparatus, wherein the storage apparatus controller replaces the specific data unit with the recovery data unit, when the specific data unit is read and is found having an error.

According to above-mentioned embodiment, logic operation such as XOR operation can be utilized to compute recovery data, and the recovery data can be utilized to substitute original data when the original data includes too much error. By this way, the data correctness can increase.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a data accessing system according to a first embodiment of the present invention.

FIG. 2 illustrates a data accessing system according to a second embodiment of the present invention.

FIG. 3 illustrates a data accessing system according to a third embodiment of the present invention.

FIG. 4 illustrates a data accessing method according to a embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

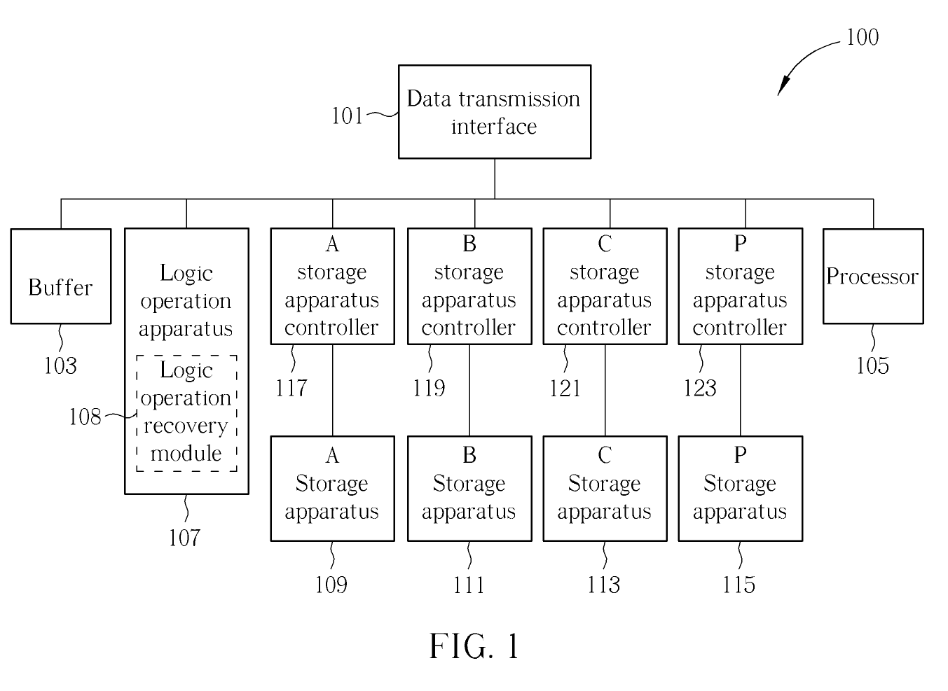

FIG. 1 illustrates a data accessing system 100 according to a first embodiment of the present invention. As shown in FIG. 1, the data accessing system 100 includes a data transmission interface 101, a buffer 103, a processor 105, a logic operation apparatus 107, an A storage apparatus 109, a B storage apparatus 111, a C storage apparatus 113, a P storage apparatus 115, a A storage apparatus controller 117, a B storage apparatus controller 119, a C storage apparatus controller 121, and a P storage apparatus controller 123. The data accessing system 100 receives data via a data transmission interface 101 (ex. USB) from a host not shown in FIG. 1 and buffers the data to the buffer 103, before the data units A, B, C are respectively written into the A storage apparatus 109, the B storage apparatus 111 and the C storage apparatus 113. Additionally, the processor 105 is utilized to read data A, B, C, and the processor 105 controls the logic operation apparatus 107 to perform a logic operation for data A, B, C to generate a logic operation data unit P.

In this embodiment, the logic operation is an XOR operation (not limited). Accordingly, the equation between the data units A, B, C and the logic operation data unit P can be shown as Equation (1):

P=A [symbol] B [symbol] C Equation (1)

The notation [symbol] in Equation (1) represents XOR operation. After this operation, data units A, B, C and the logic operation data unit P will be respectively stored to the A storage apparatus 109, the B storage apparatus 111, the C storage apparatus 113 and the P storage apparatus 115. The logic operation data unit P can be regarded as parity check code of the data units A, B and C. The data length of the logic operation data unit P is determined according to the data length of data units A, B and C. For example, if the data amount of data units A, B, C is one bit, the data amount of the logic operation data unit P is one bit as well. However, if the data amount of data units A, B, C is 512 bytes, the data amount of the logic operation data unit P is 512 bytes as well.

At the same time of performing logic operation to generate the logic operation data unit P (suppose the data amounts of data units A, B and C are all 512 byte), the logic operation apparatus 107 can utilize the first bit of data units A, B and C to generate a first bit of the logic operation data unit P, utilize the second bit of data units A, B and C to generate a second bit of the logic operation data unit P . . . and utilize the 512^{th} bit of data units A, B and C to generate a 512^{th} bit of the logic operation data unit P. Additionally, the logic operation apparatus 107 can utilize other specific rules to generate the logic operation data unit P. For example, the logic operation apparatus 107 can utilize a first bit of the data unit A, a second bit of the data unit B, a third bit of the data unit C to generate a first bit of logic operation data unit P; or utilizes a second bit of the data unit A, a third bit of the data unit B, a forth bit of data unit C to generate a second bit of logic operation data unit P; or utilizes a 512^{th} bit of the data unit A, a first bit of the data unit B, a second bit of the data unit C to generate a 512 bit of the logic operation data unit P. In other words, the logic operation apparatus 107 not only can utilize an n^{th} bit of data units A, B, C to generate an n^{th} bit of the logic operation data unit P, but also can utilize a^{th}, b^{th}, and C^{th} bits of data units A, B, C to generate a d^{th} bit of the logic operation data unit P, wherein a, b, c, d and n are different positive integers.

When the data accessing system 100 wants to read the data units A, B and C stored in the A storage apparatus 109, the B storage apparatus 111 or the C storage apparatus 113, the A storage apparatus controller 117, the B storage apparatus controller 119, and the C storage apparatus controller 121 read data units A, B, C from the A storage apparatus 109, the B storage apparatus 111, and the C storage apparatus 113 and buffer to the buffer 103. Also, the data units A, B, C are performed error correction (ex. utilizing ECC) as well. Besides, if data units A, B, C are performed error correction and some uncorrectable error is found therein, corresponding storage apparatus controller will report such situation to the processor 105. In this case, the processor 105 will control the logic operation apparatus 107 such that a logic operation recovery module 108 in the logic operation apparatus 107 utilizes data units A, B, C and the logic operation data unit P to respectively compute recovery data A′, B′ or C′, as shown in following equations (2)˜(4):

A′=B [symbol] C [symbol] P Equation (2)

B′=A [symbol] C [symbol] P Equation (3)

C′=A [symbol] C [symbol] P Equation (4)

The notation [symbol] in Equations (2)˜(4) represents XOR operation. For more detail, in one embodiment, a host wants to read data units A, and then the A storage apparatus controller 117 reads the data unit A from the A storage apparatus 109 and performs error correction to which (ex. utilizing ECC). Besides, the A storage apparatus controller 117 will report this situation to the processor 105, when the A storage apparatus controller 117 finds that the data unit A has too many errors for ECC to correct. In this case, the processor 105 controls the B storage apparatus controller 119, the C storage apparatus controller 121 and the P storage controller 123 to respectively read corresponding data units B, C, P from the B storage apparatus 111, and the C storage apparatus 113. Additionally, the processor 105 utilizes ECC to respectively perform error correction to data units B, C and P. If data units B, C, P are all correct data or can be corrected to correct data, the processor 105 can acquire it and control the logic operation apparatus 107, such that a logic operation recovery module 108 in the logic operation apparatus 107 can utilize data units B, C and the logic operation data unit P to compute recovery data A′, as shown in Equation (2).

The operation of the logic operation recovery module 108 to utilize data units B, C and the logic operation data unit P to compute the recovery data A′ depend on how the logic operation apparatus 107 generates the logic operation data unit P. For example, if the logic operation apparatus 107 utilizes a first bit of the data units A, B, C to generate a first bit of the logic operation data unit P, the logic operation recovery module 108 utilizes a first bit of the data units A, B, C and the logic operation data unit P to generate a first bit of the recovery data A′ . . . and so on.

Accordingly, if the data units A, B and C stored in the A storage apparatus 109, the B storage apparatus 111 and the C storage apparatus 113 have too much error to be corrected, the A storage controller 117, the B storage controller 119 and the C storage controller 121 utilize corresponding data to replace original data (ex. A′ corresponding to A, B′ corresponding to B, C′ corresponding to C), in similar way. By this way, correct data still can be maintained, even if data units A, B, C have too much error to be corrected.

Besides, for more convenient management, the data units A, B, C and the logic operation data unit P can be stored in a specific order. For example, in one embodiment, the data amount of data units A, B, C and the logic operation data unit P is one page. For example, the data units A, B, C and the logic operation data unit P can be respectively stored to a first physical page of the A storage apparatus, the B storage apparatus, the C storage apparatus and the P storage apparatus. By this way, data units B, C and the logic operation data unit P can be rapidly found according to the address of the data unit A, when uncorrectable error occurs to the data unit A. Furthermore, in another embodiment, the data units A, B, C and the logic operation data unit P can be respectively stored to any page of the A storage apparatus, the B storage apparatus, the C storage apparatus and the P storage apparatus. Additionally, a logic operation table is build to record storage addresses for the data units A, B, C and the logic operation data unit P. The logic operation table can be looked up to find data units B, C and the logic data unit P, if uncorrectable error is found while reading the data unit A.

In this embodiment, the logic operation apparatus 107 can be replaced by firmware. Also, the logic operation recovery module 108 can be implemented by software or hardware. Furthermore, the logic operation data unit P is not limited to be generated by data units A, B and C . For example, the logic operation data unit P can be generated by two (ex. data units A, B or data units B, C) or more than three data units.

Additionally, in one embodiment, the data accessing system 100 can further include another buffer to buffer the logic operation data unit P computed by the logic operation apparatus 107, and stores the logic operation data unit P to the P storage apparatus 105. Alternatively, the buffer 103 can also be utilized to reach such function. In this case, the buffer 103 needs larger storage space, however.

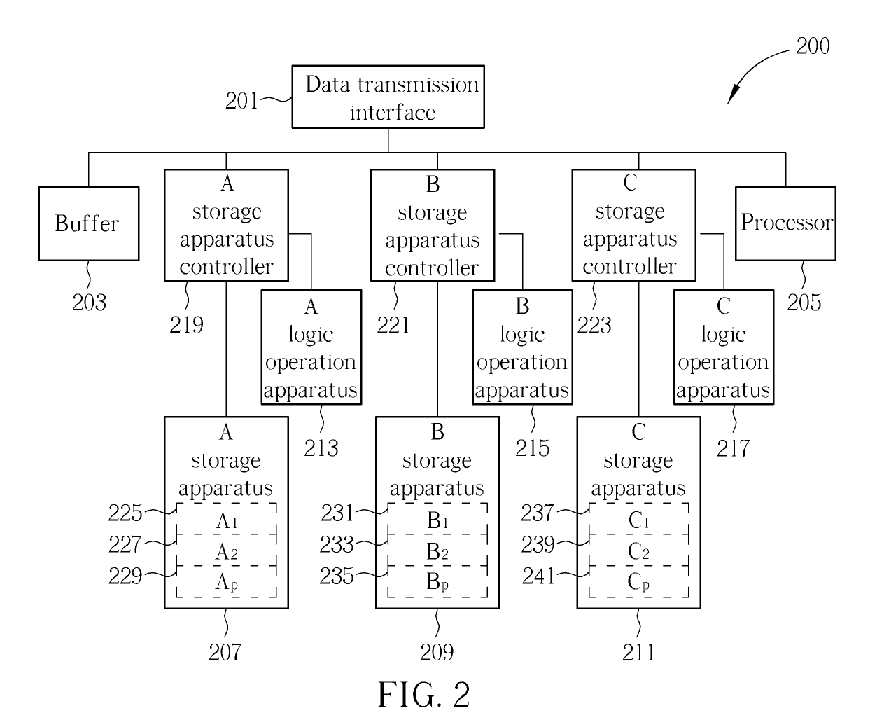

FIG. 2 illustrates a data accessing system 200 according to a second embodiment of the present invention. Compare with the data accessing system 100 and 200. The data accessing system 200 includes an A logic operation apparatus 213, a B logic operation apparatus 215 and a C logic operation apparatus 217 in addition to the similar devices in the data accessing system 100: the interface 201, the buffer 203, and the processor 205. The A logic operation apparatus 213, the B logic operation apparatus 215 and the C logic operation apparatus 217 are respectively coupled to the A storage controller 219, the B storage controller 221, the C storage controller 223, to respectively perform logic operation to data stored in the A storage apparatus 207, the B storage apparatus 209 and the C storage apparatus 211. The A storage apparatus 207, B storage apparatus 209 and C storage apparatus 211 respectively utilize independent channels to communicate with the processor 205. The logic operation apparatuses 213˜217 can be implemented by hardware or hard code. The hard code means respectively writing program to the A storage controller 219, the B storage controller 221, or the C storage controller 223 to fulfill the function of logic operation apparatus.

Furthermore, in the data accessing system 200, the A storage apparatus 207, B storage apparatus 209 and C storage apparatus 211 are all flash memories, and the data units processed by the logic operation apparatuses 213˜217 are pages. For example, the A logic operation apparatus 213 will perform a logic operation to the A₁ data unit 225 and the A₂ data unit 227 to generate A_{P} data unit 229. The B logic operation apparatus 215 will perform a logic operation to the B₁ data unit 231 and the B₂ data unit 233 to generate B_{P} data unit 235. The C logic operation apparatus 217 will perform a logic operation to the C₁ data unit 237 and the C₂ data unit 239 to generate C_{P} data unit 241. Furthermore, according to the operation described in FIG. 1, the data accessing system 100 reads data units A, B, C from the buffer 103 and performs logic operation to which and then stores the result to the P storage apparatus 115. Accordingly, other buffers are needed to register the logic operation data P and then store the logic operation data P to the P storage apparatus 115.

Besides, in the data accessing system 200, the data units A₁˜C₂ are read from the buffer 203. In this case, the A logic operation apparatus 213, the B logic operation apparatus 215 and the C logic operation apparatus 217 perform logic operation to data units A₁˜C₂ and simultaneously store corresponding logic operation data units (ex. Ap, Bp, Cp) to the A storage apparatus 207, the B storage apparatus 209 and the C storage apparatus 211. Accordingly, high capacity buffers or extra buffers are not needed in such case.

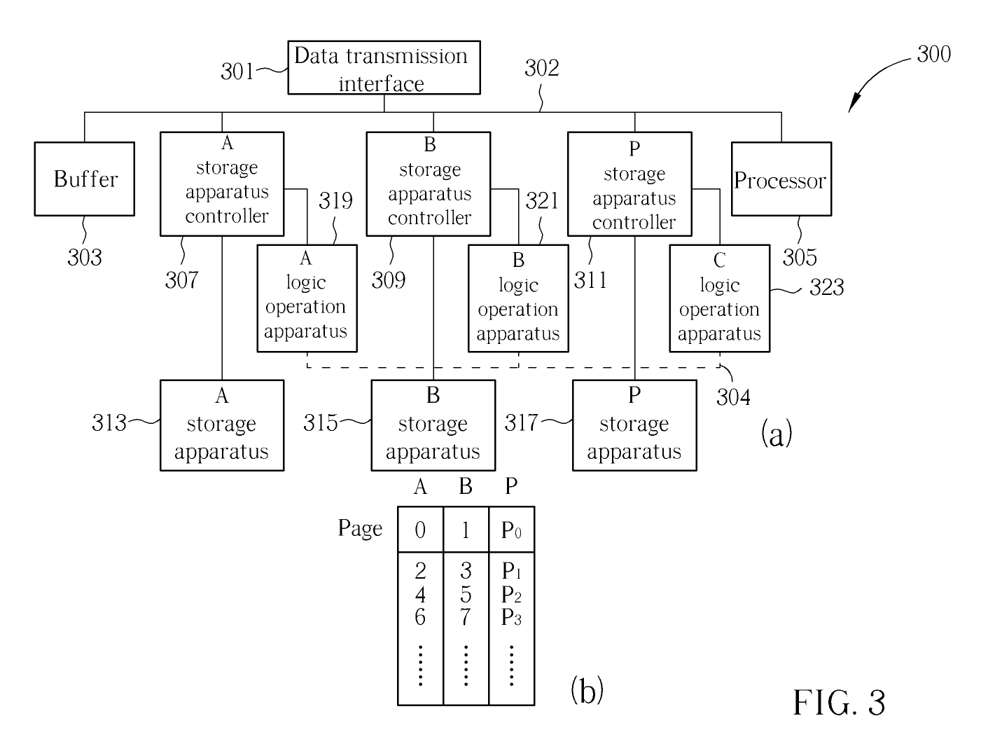

FIG. 3 illustrates a data accessing system 300 according to a third embodiment of the present invention. The data accessing system 300 includes a structure similar with data accessing system 200. That is, the data accessing system 300 includes similar devices with the data accessing system 200: the data transmission interface 301, the buffer 303, the processor 305, the storage apparatus controller A 307, the storage apparatus controller B 309, the storage apparatus controller P 311, the storage apparatus A 313, the storage apparatus B 315, the storage apparatus P 317 and the logic operation apparatuses 319, 321 and 323, as shown in FIG. 3 (a). One difference between the data accessing system 300 and the data accessing system 200 is that the logic operation apparatuses 319˜323 utilize pages as an unit to process data stored in the A storage apparatus 313, the B storage apparatus 315, and the P storage apparatus 317. In other words, different pages of the same block are respectively stored to the A storage apparatus 313 and the B storage apparatus 315. The logic operation apparatuses 319, 321 and 323 store logic operation data to the P storage apparatus 317 after perform logic operations to pages in the A storage apparatus 313, and the B storage apparatus 315.

As shown in FIG. 3 (b), a page Page0 is stored in the A storage apparatus 313, a page Page1 is stored in the B storage apparatus 315, and a logic operation page P₀ computed from the pages Page0 and Page 1 is stored to the P storage apparatus 317. Similarly, a page Page2 of the same block is stored in the A storage apparatus 313, a page Page 3 of the same block is stored in the B storage apparatus 315, and a logic operation page P₁ computed from the pages Page 2 and Page 3 is stored to the P storage apparatus 317. The pages of the same block are stored in different storage apparatuses in such arrangement. Accordingly, the data stored in all pages of the same block will not lose, even if one storage apparatus is broken. Also, in this embodiment, a bus 304 can be further added between each logic operation apparatus for negotiation and data transmission, besides the bus 302 for the data transmission interface, the buffer and the storage apparatus.

Similarly, the logic operation apparatuses 319˜323 can be implemented by hardware or hard code. The hard code means respectively writing program to the A storage controller 313, the B storage controller 315, or the P storage controller 317 to fulfill the function of logic operation apparatus.

Above-mentioned data accessing system is only for example and does not mean to limit the scope of the present application. For example, the storage apparatus is not limited to flash memory, and the data unit for process is not limited to page or block. Additionally, the arrangement of the logic operation apparatus is not limited to above-mentioned embodiment. For example, the arrangement of the data accessing system 100 can be utilized to the data accessing systems 200 and 300. Similarly, the arrangement for the logic operation apparatus of the data accessing systems 200 and 300 can be utilized to other data accessing systems.

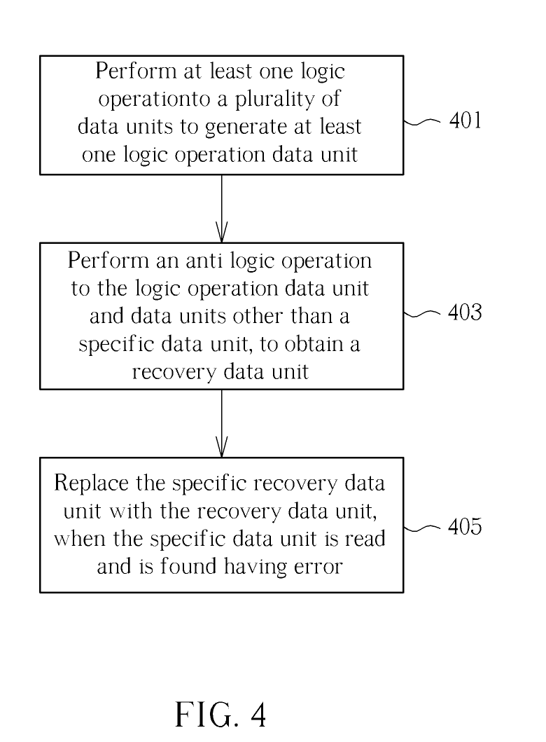

FIG. 4 illustrates a data accessing method according to a embodiment of the present invention. The data accessing method includes:

Step 401

Perform at least one logic operation (ex. XOR operation) to a plurality of data units (ex. block or page of a flash) to generate at least one logic operation data unit.

Step 403

Perform an anti logic operation to the logic operation data unit and data units other than a specific data unit, to obtain a recovery data unit. For example, in the embodiment shown in FIG. 1, utilize equation (2) to perform an anti logic operation to the data units B, C and the logic operation data unit P to acquire recovery data A′.

Step 405

Replace the specific recovery data unit with the recovery data unit, when the specific data unit is read and is found having error.

Other detail of the data accessing method according to one embodiment of the present invention is already disclosed in above mentioned embodiment, thus it is omitted for brevity here.

According to above-mentioned embodiment, logic operation such as XOR operation can be utilized to compute recovery data, and the recovery data can be utilized to substitute original data when the original data includes too much error. By this way, the data correctness can increase.

Those skilled in the art will readily observe that numerous modifications and alterations of the device and method may be made while retaining the teachings of the invention.

What is claimed is:

1. A data accessing method for a data accessing system, comprising:
(a) performing a logic operation to a plurality of data units to generate at least one logic operation data unit;
(b) performing an anti logic operation to the logic operation data unit and an other data unit to obtain a recovery data unit wherein the other data unit comprises the data units except a specific data unit in the data units; and
(c) replacing the specific data unit with the recovery data unit, when the specific data unit is read and is found having an error.

2. The data accessing method of claim 1, wherein the step (c) utilizes the recovery data unit to replace with the specific data unit only when the error of the specific data unit can not be corrected.

3. The data accessing method of claim 1, wherein the logic operation is XOR operation.

4. The data accessing method of claim 1, where in the data units are blocks of a flash memory.

5. The data accessing method of claim 4, further comprising:
storing the logic operation data unit after the logic operation is performed to all the data units and the logic operation data unit is fully generated.

6. The data accessing method of claim 4, comprising:
storing a corresponding part of the logic operation data units when a part of the data units is performed the logic operation and the corresponding part of the logic operation data unit is generated.

7. The data accessing method of claim 1, wherein the data units are pages of a flash memory.

8. The data accessing method of claim 1, wherein the data units are respectively stored in a plurality of storage apparatuses, and each of the storage apparatuses has a corresponding logic operation apparatus to perform the logic operation.

9. The data accessing method of claim 1, wherein the logic operation data unit and the data units for generating the logic operation data unit are stored in the same storage apparatuses.

10. The data accessing method of claim 1, wherein the logic operation data unit and the data units for generating the logic operation data unit are stored in different storage apparatuses.

11. A data accessing system applied to a data accessing system, comprising:
at least one storage apparatus;
a logic operation apparatus, for performing a logic operation to a plurality of data units to generate at least one logic operation data unit before the data units are stored to the storage apparatus, and for performing an anti logic operation to the logic operation data unit and an other data unit to obtain a recovery data unit wherein the other data unit comprises the data units except a specific data unit in the data units; and
at least one storage apparatus controller, for controlling the storage apparatus, wherein the storage apparatus controller replaces the specific data unit with the recovery data unit, when the specific data unit is read and is found having an error.

12. The data accessing system of claim 11, wherein the storage apparatus controller utilizes the recovery data unit to replace with the specific data unit only when the error of the specific data unit can not be corrected.

13. The data accessing system of claim 11, wherein the logic operation apparatus performs a XOR operation.

14. The data accessing system of claim 11, where in the data units are blocks of a flash memory.

15. The data accessing system of claim 14, wherein the storage apparatus controller stores the logic operation data unit after the logic operation is performed to all the data units and the logic operation data unit is fully generated.

16. The data accessing system of claim 14, wherein the storage apparatus controller stores a corresponding part of the logic operation data units when a part of the data units is performed the logic operation and the corresponding part of the logic operation data unit is generated.

17. The data accessing system of claim 11, wherein the data units are pages of a flash memory.

18. The data accessing system of claim 11, wherein the data units are respectively stored in a plurality of storage apparatuses, and each of the storage apparatuses has a corresponding logic operation apparatus to perform the logic operation.

19. The data accessing system of claim 11, wherein the logic operation data unit and the data unit for generating the logic operation data unit are stored in the same storage apparatuses.

20. The data accessing system of claim 11, wherein the logic operation data unit and the data units for generating the logic operation data unit are stored in different storage apparatuses.
